(19) United States
(12) Patent Application Publication
(10) Pub. No.: US 2008/0158187 A1
(43) Pub. Date: Jul. 3, 2008

(54) Touch control input system for use in electronic apparatuses and signal generation method thereof

(76) Inventors: David Ho, Shanghai (CN); Ching-Sung Chang, Taipei (TW); Tony Tsai, Shanghai (CN); Wei Shen, Shanghai (CN)

Correspondence Address: ROSENBERG, KLEIN & LEE, 3458 ELLICOTT CENTER DRIVE-SUITE 101, ELLICOTT CITY, MD, 21043, US

(21) Appl. No.: 11/802,598

(22) Filed: May 24, 2007

(30) Foreign Application Priority Data
Dec. 29, 2006 (TW) 095150036

(51) Int. Cl. G06F 3/041

(52) U.S. Cl. 345/173

(57) ABSTRACT

A touch control input system and a signal generation method are provided. The touch control input system includes a touch control interface, a sensor unit, and a control unit. The touch control input system is featured by sectioning a plurality of blocks based on a plurality of grid lines for constructing the touch control interface so as to identify the displace movement of an external operator based on the blocks. The sensor unit functions to detect changes of logic states of the blocks. Accordingly, the control unit is able to identify the displace movement from one grid line to the other grid line through the detected changes of logic states, which in turn can be utilized to generate a displacement data for controlling electronic apparatuses.

### BACKGROUND OF THE INVENTION

1. Field of the Invention

The present invention relates in general to a touch control input system and a signal generation method and, more particularly, to a touch control input system and method having detecting mechanism based on grid lines in a touch control interface for use in electronic apparatuses.

2. Description of the Prior Art

In general, most of existing electronic apparatuses provide various types of input means for moving cursors or selecting options on a display screen. The input means may include a keyboard, a mouse, a track ball, a touch control panel, a joystick, or a touch control screen. Furthermore, concerning about portable electronic apparatuses, such as a multimedia playback, a mobile phone, a notebook computer, or a personal digital assistant (PDA), the touch control panel and the touch control screen are likely to be used as input means.

While operating a touch control panel, control signals of the touch control panel can be generated by moving a finger or a touch pen on the surface of the touch control panel. Concurrently, an input pointer, such as a cursor, undergoes a corresponding displacement with respect to the movement of the finger or the touch pen.

It is well known that the touch control panel comprises at least one sensor for detecting the movement of the finger or the touch pen. The sensors used are normally dispersedly installed in the touch control panel. That is to say, each installed sensor is located at different coordinate position. Basically, the coordinates of each installed sensor are addressed according to column and row of corresponding grid allocation. The displacement of the input pointer is controlled by detected position signals concerning the movement of the finger or the touch pen sliding across adjacent grids corresponding to different sensors having different coordinates.

Among various types of touch control panels, a capacitive sensing touch control panel is the most popular type. The capacitive sensing touch control panel normally comprises several material layers, such as a shield cover, at least one electrode layer, and a circuit board. The shield cover overlays the electrode layer for touch protection. The electrode layer is bedded in the capacitive sensing touch control panel between the shield cover and the front side of the circuit board.

Users can touch the shield cover for controlling the displacement of a cursor on a screen. In another aspect, the electrode layer is able to detect the touching position having coordinates X and Y while the finger of a user is touching the shield cover at a halt or sliding. The electrode layer usually comprises a plurality of electrodes, the position of each electrode is addressed by corresponding row and column coordinates for arranging grid arrays.

The touch control panel may further comprise sensing electronic devices to detect sensing signals concerning corresponding electrodes. For instance, while the finger sliding across grids, the sensing electronic devices are able to detect change of capacitance value corresponding to each electrode. The sensing electronic devices are normally installed at the back side of the circuit board. The sensing electronic devices may comprise integrated circuits for gauging the capacitance value of each electrode. Based on the measured capacitance value of each electrode, the movement of the finger can be estimated.

Please refer to FIG. 1. FIG. 1 shows a schematic diagram of a prior art touch control panel. The touch control panel 11 includes a shield cover 111 and a plurality of electrodes 112. The plurality of electrodes 112 are arranged as a plurality of grids having rectangular figure and are bedded beneath the shield cover 111. The position of each electrode 112 is addressed by different coordinates X and Y individually. While a finger 13 is moving toward the electrodes 112, minute electronic signals are induced at the electrodes 112 around the finger 13. The minute electronic signals are thereby utilized to generate X and Y input signals 10 corresponding to the electrodes 112 around the finger 13. The X and Y input signals 10 are used to control displacement of a cursor 122 displayed on the screen 121 in accordance with the corresponding movement of the finger 13 along X and Y directions.

However, in the above-mentioned prior art, while the finger is making a speedy movement, accurate positioning between adjacent electrode grids is difficult to be performed. Furthermore, finger trembling or other uncertainty factors may result in unstable or jitter signals induced by the electrodes. Consequently, touch control operation is not going to operate properly under such circumstance.

For that reason, the present invention provides a touch control input system and a signal generation method to solve the aforementioned problems.

### SUMMARY OF THE INVENTION

It is therefore a primary objective of the present invention to provide a touch control input system and a signal generation method having detecting mechanism based on grid lines in a touch control interface for use in electronic apparatuses to solve the prior art problems.

In accordance with an objective of the present invention, a touch control input system for use in an electronic apparatus is provided for generating a displacement data to control movement of an input pointer of the electronic apparatus. The touch control input system comprises a touch control interface, at least one sensor unit, and a control unit.

The touch control interface has a plurality of blocks sectioned by a plurality of grid lines for providing an external operator performing a displace movement. The sensor unit coupled to the touch control interface is utilized for sensing changes of logic states of the blocks. The control unit coupled to the sensor unit is utilized for determining a displace movement from one grid line to the other grid line based on the change of logic state so as to generate the displacement data.

The present invention further provides a signal generation method for use in a touch control input system of an electronic apparatus. The signal generation method comprises: providing a touch control interface having a plurality of grid lines and a plurality of blocks sectioned by the grid lines, performing a displace movement by an external operator on the touch control interface, generating changes of logic states corresponding to the plurality of blocks based on the displace movement, and determining the displace movement from one grid line to the other grid line by a control unit for generating a displacement data based on the changes of logic states.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The above and other objects and features of the present invention will become apparent from the subsequent description of preferred embodiments given in conjunction with the following accompanying drawings.

FIG. 1 shows a schematic diagram of a prior art touch control panel.

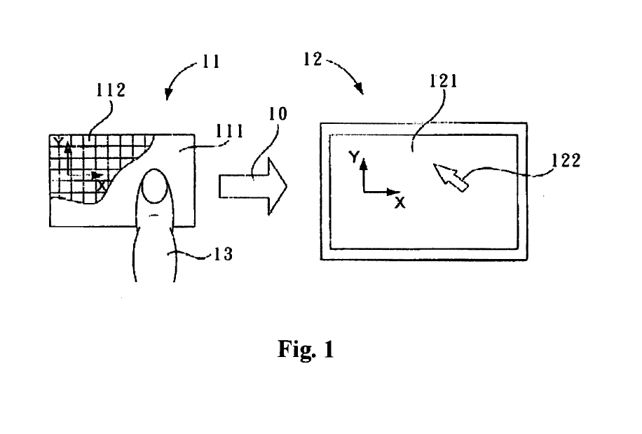

FIG. 2 shows a schematic diagram of a touch control input system in accordance with a preferred embodiment of the present invention.

FIG. 3 is a schematic diagram illustrating operational situations in accordance with the touch control input system of the preset invention.

FIG. 4 provides a schematic diagram of a first preferred embodiment of the touch control interface according to the present invention.

FIG. 5 provides a schematic diagram of a second preferred embodiment of the touch control interface according to the present invention.

FIG. 6 provides a schematic diagram of a third preferred embodiment of the touch control interface according to the present invention.

FIG. 7 provides a schematic diagram of a fourth preferred embodiment of the touch control interface according to the present invention.

FIG. 8 sets forth a flowchart depicting a signal generating method based on the touch control input system in FIG. 2 according to the present invention.

FIG. 9 illustrates a flowchart depicting a signal generating method in accordance with a preferred embodiment of the present invention.

### DETAILED DESCRIPTION OF THE PREFERRED EMBODIMENT

Hereinafter, preferred embodiments of the present invention will be described in detail with reference to the accompanying drawings. Here, it is to be noted that the present invention is not limited thereto.

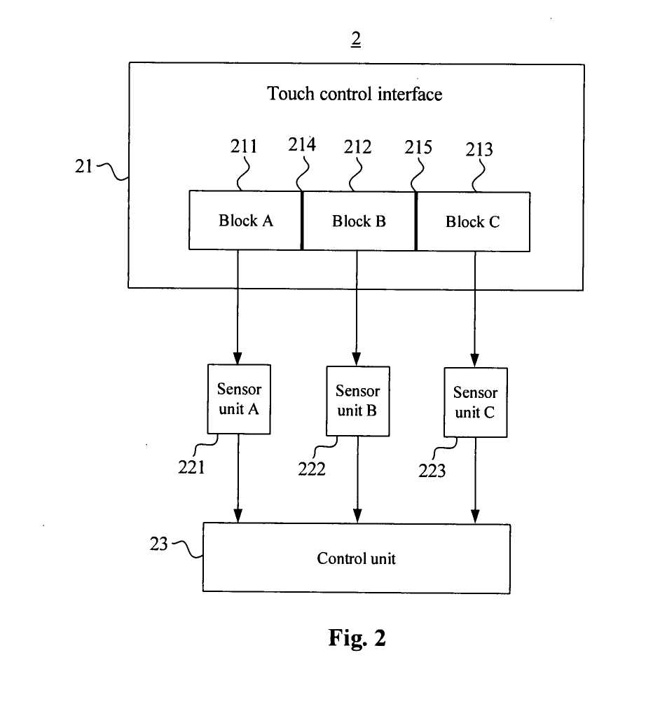

Please refer to FIG. 2. FIG. 2 shows a schematic diagram of a touch control input system in accordance with a preferred embodiment of the present invention. The touch control input system 2 comprises a touch control interface 21, a sensor unit A221, a sensor unit B222, a sensor unit C223, and a control unit 23. The touch control interface 21 comprises a block A211, a block B212, and a block C213. The top surface of the touch control interface 21 is a touch surface provided for performing a displace movement by an operator. A grid line 214 is deployed between the block A211 and the block B212. Moreover, a grid line 215 is deployed between the block B212 and the block C213.

The sensor unit A221 is correspondingly installed underneath the block A211 and is utilized to detect whether or not there is a physical or electrical change of logic state occurring to the block A211. The sensor unit B222 is correspondingly installed underneath the block B212 and is utilized to detect whether or not there is a physical or electrical change of logic state occurring to the block B212. The sensor unit C223 is correspondingly installed underneath the block B213 and is utilized to detect whether or not there is a physical or electrical change of logic state occurring to the block C213. The control unit 23 functions to determine the displace movement performed by the operator based on the changes of logic states detected by the sensor unit A221, the sensor unit B222, and the sensor unit C223.

When the block A211 and the block B212 having changes of logic states by touching are detected and the block C213 is not detected to have any change of logic state by touching, the control unit 23 determines that the operator is currently performing a touching at the position of the grid line 214. The control unit 23 then generates a first position signal according to the position of the grid line 214. Thereafter, when the block B212 and the block C213 are detected having changes of logic states by touching and the block A211 is not detected to have any change of logic state by touching, the control unit 23 determines that the operator has shifted the touching to the position of the grid line 215. The control unit 23 then generates a second position signal according to the position of the grid line 215. Accordingly, the control unit 23 is able to generate a displacement data for controlling movement of an input pointer of an electronic apparatus based on the first position signal and the second position signal. The abovementioned electronic apparatus can be a portable electronic apparatus such as a multimedia playback, a mobile phone, a notebook computer, or a personal digital assistant (PDA).

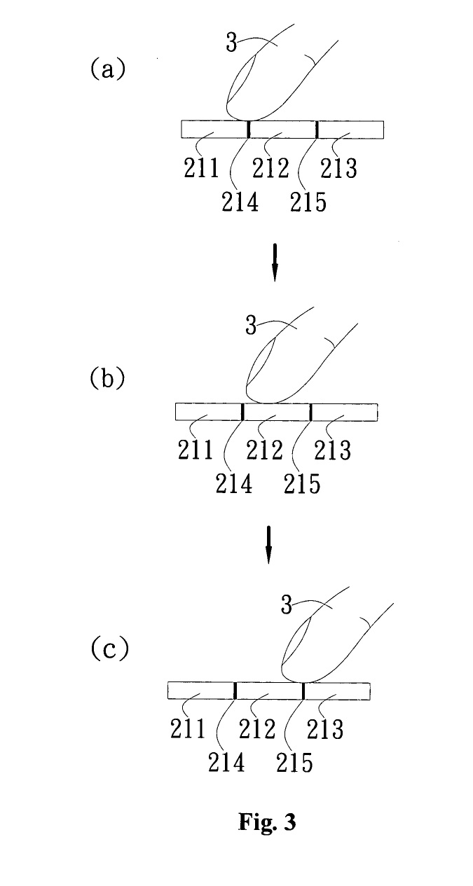

Please refer to FIG. 3. FIG. 3 is a schematic diagram illustrating operational situations in accordance with the touch control input system of the preset invention. FIG. 3(a) shows the operational situation (a) that a finger 3 of the operator is touching the grid line 214, which results in generating the first position signal by the control unit 23. FIG. 3(b) shows the operational situation (b) that the finger 3 of the operator is touching the block B212 only, which will not cause any signal generated by the control unit 23. FIG. 3(c) shows the operational situation (c) that the finger 3 of the operator is touching the grid line 215, which results in generating the second position signal by the control unit 23. Based on the operational situations from (a) to (c), the control unit is able to generate the displacement data depicting the movement from the grid line 214 toward the grid line 215.

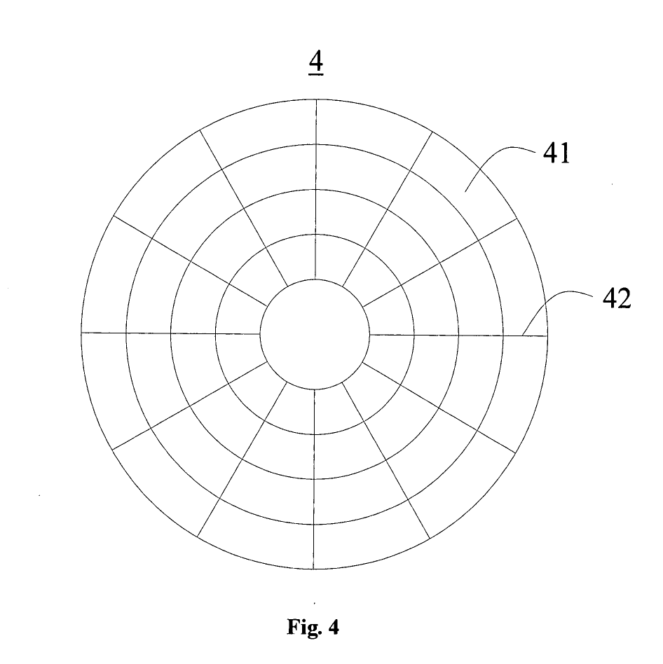

Please refer to FIG. 4 through FIG. 7. FIG. 4 provides a schematic diagram of a first preferred embodiment of the touch control interface according to the present invention. The touch control interface 4 comprises a plurality of sectioning lines 42 and a plurality of blocks 41. The plurality of sectioning lines 42 comprises a plurality of circles having same center and different radius and a plurality of radiation-like lines. Each block 41 is enclosed by two adjacent circles and two adjacent radiation-like lines.

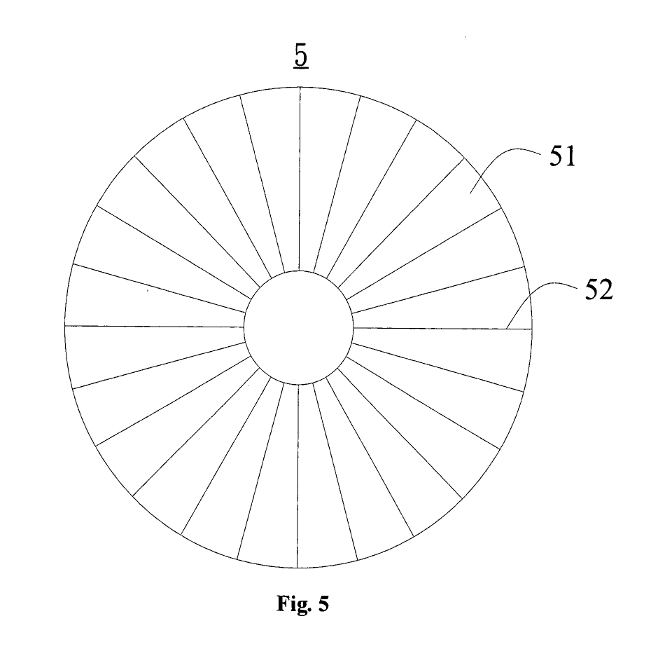

FIG. 5 provides a schematic diagram of a second preferred embodiment of the touch control interface according to the present invention. The touch control interface 5 comprises a plurality of sectioning lines 52 and a plurality of blocks 51. The plurality of sectioning lines 42 comprises a plurality of radiation-like lines. Each block 51 is enclosed by two adjacent radiation-like lines.

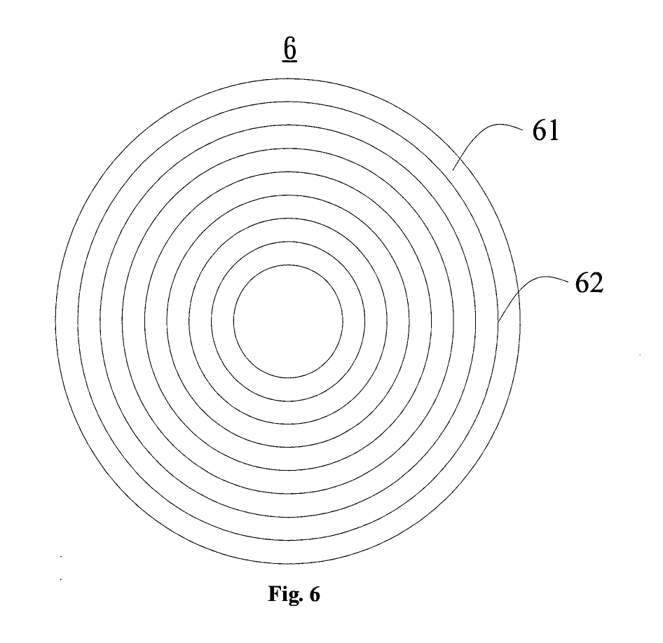

FIG. 6 provides a schematic diagram of a third preferred embodiment of the touch control interface according to the present invention. The touch control interface 6 comprises a plurality of sectioning lines 62 and a plurality of blocks 61. The plurality of sectioning lines 62 comprises a plurality of circles having same center and different radius. Each block 61 is enclosed by two adjacent circles.

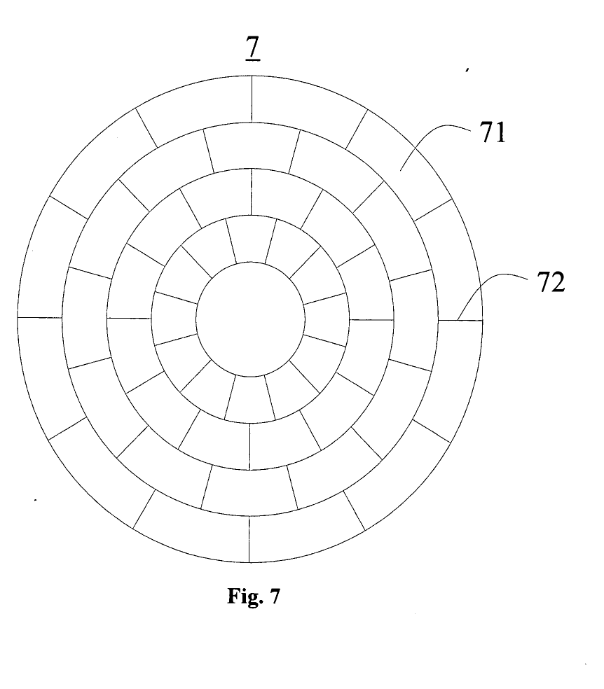

FIG. 7 provides a schematic diagram of a fourth preferred embodiment of the touch control interface according to the present invention. The touch control interface 7 comprises a plurality of sectioning lines 72 and a plurality of blocks 71. The plurality of sectioning lines 72 comprises a plurality of circles having same center and different radius and a plurality of radiation-like lines. The radiation-like lines are discontinuous as shown in FIG. 7. Each block 71 is enclosed by two adjacent circles and two adjacent radiation-like lines.

The areas or widths of the blocks 41, 51, 61, and 71 are properly designed so as to match the touch area of the finger 3 of the operator. The grid lines 42, 52, 62, and 72 have recess or protrude design so as to improve sense feeling of the finger 3 while performing touch operations.

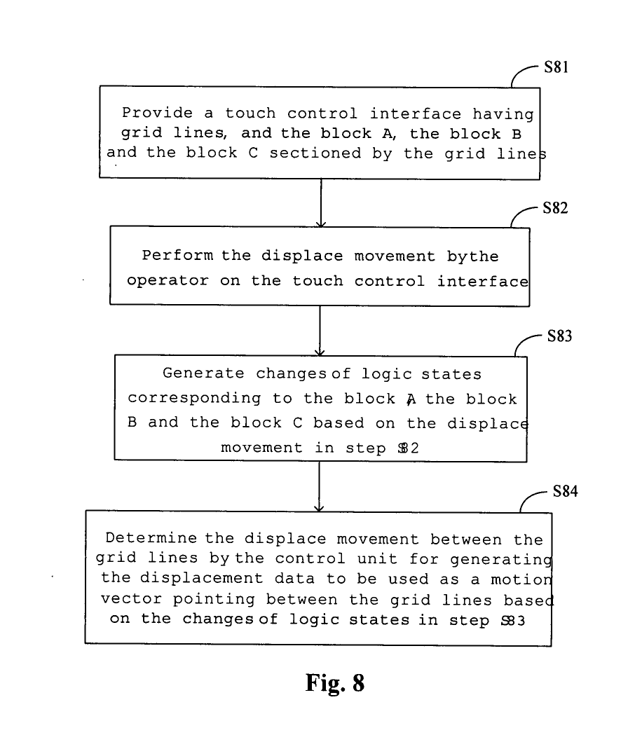

Please refer to FIG. 8. FIG. 8 sets forth a flowchart depicting a signal generating method based on the aforementioned touch control input system 2 according to the present invention. The signal generating method comprises the following steps:
Step S81: provide a touch control interface 21 having grid lines 214 and 215, and the block A211, the block B212 and the block C213 sectioned by the grid lines 214 and 215;
Step S82: perform the displace movement by the operator on the touch control interface 21;
Step S83: generate changes of logic states corresponding to the block A211, the block B212 and the block C213 based on the displace movement in step S82; and
Step S84: determine the displace movement from the grid line 214 toward the grid line 215 by the control unit 23 for generating the displacement data to be used as a motion vector pointing from the grid line 214 to the grid line 215 based on the changes of logic states in step S83.

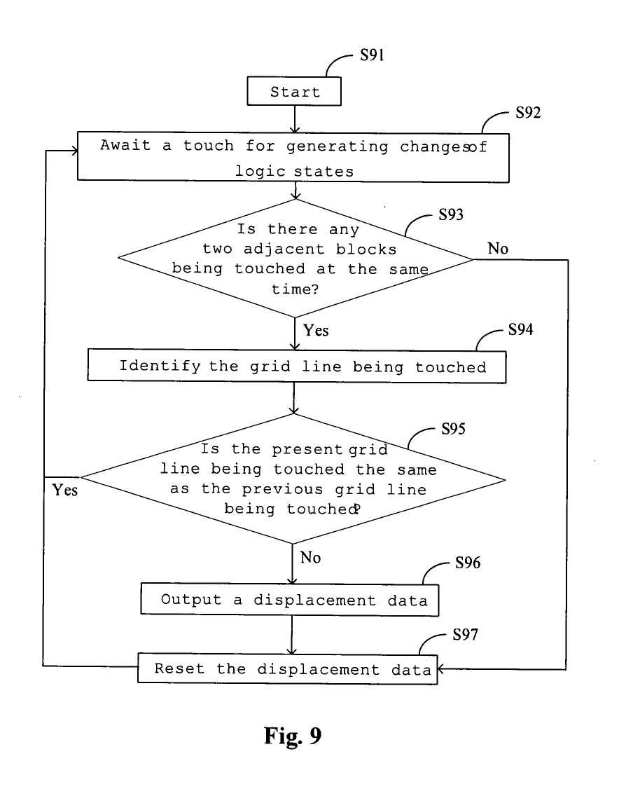

Please refer to FIG. 9. FIG. 9 illustrates a flowchart depicting a signal generating method in accordance with a preferred embodiment of the present invention. The signal generating method comprises the following steps:
Step S91: start;
Step S92: await a touch by an external object such as a finger or a touch pen for generating changes of logic states;
Step S93: determine whether or not there are two adjacent blocks being touched at the same time based on the changes of logic states, if there are two adjacent blocks being touched at the same time, then go to step S94, otherwise go to step S97;
Step S94: identify the grid line bordered by the two adjacent blocks being touched at the same time as the present grid line being touched;
Step S95: determine whether or not the present grid line being touched is the same as the previous grid line being touched, if the present grid line being touched is the same as the previous grid line being touched, then go back to step S92, otherwise go to step S96;
Step S96: output a displacement data based on the present grid line being touched and the previous grid line being touched; and
Step S97: reset the displacement data and go back to step S92.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A touch control input system for use in an electronic apparatus, applied to generate a displacement data for controlling the electronic apparatus, the touch control input system comprising:
a touch control interface having a plurality of blocks sectioned by a plurality of grid lines, for an operator performing a displace movement;
at least one sensor unit, coupled to the touch control interface, for sensing changes of logic states of the blocks; and
a control unit, coupled to the sensor unit, for determining the displace movement from a first grid line to a second grid line of the grid lines based on the changes of logic states so as to generate a displacement data.

2. The touch control input system of claim 1, wherein the displacement data comprises a first position signal and a second position signal.

3. The touch control input system of claim 2, wherein the control unit generates the first position signal when the external operator is performing the displace movement at the first grid line.

4. The touch control input system of claim 3, wherein the control unit generates the second position signal when the external operator is performing the displace movement at the second grid line.

5. The touch control input system of claim 1, wherein the control unit determines that the displace movement is positioned at the first grid line when the changes of logic states are corresponding to two adjacent blocks bordering the first grid line.

6. The touch control input system of claim 1, wherein the electronic apparatus is a portable electronic apparatus such as a multimedia playback, a mobile phone, a notebook computer, or a personal digital assistant (PDA).

7. A signal generation method for use in a touch control input system of an electronic apparatus, the signal generation method comprising:
providing a touch control interface having a plurality of grid lines and a plurality of blocks sectioned by the grid lines;
performing a displace movement by an operator on the touch control interface;
generating changes of logic states corresponding to the plurality of blocks based on the displace movement; and
determining the displace movement from a first grid line to a second grid line of the grid lines by a control unit for generating a displacement data based on the changes of logic states.

8. The signal generation method of claim 7, wherein the displacement data comprises a first position signal and a second position signal.

9. The signal generation method of claim 8, wherein the control unit generates the first position signal when the external operator is performing the displace movement at the first grid line.

10. The signal generation method of claim 9, wherein the control unit generates the second position signal when the external operator is performing the displace movement at the second grid line.

11. The signal generation method of claim 7, wherein the control unit determines that the displace movement is positioned at the first grid line when the changes of logic states are corresponding to two adjacent blocks bordering the first grid line.

12. The signal generation method of claim 7, wherein the electronic apparatus is a portable electronic apparatus such as a multimedia playback, a mobile phone, a notebook computer, or a personal digital assistant (PDA).
